(19) United States
(12) Patent Application Publication
(10) Pub. No.: US 2006/0083110 A1
(43) Pub. Date: Apr. 20, 2006

(54) Ambient bistatic echo ranging system and method

(76) Inventor: Byron W. Tietjen, Baldwinsville, NY (US)

Correspondence Address: PLEVY & HOWARD, P.C., P.O. BOX 226, FORT WASHINGTON, PA, 19034, US

(21) Appl. No.: 10/968,751

(22) Filed: Oct. 19, 2004

(51) Int. Cl. G01S 3/80

(52) U.S. Cl. 367/127

(57) ABSTRACT

A system and associated method for ranging an underwater target of interest using ambient acoustic energy from an acoustic source. The system includes a hydrophone; a correlator for correlating first and second acoustic energy originating from the acoustic source to determine a delay associated with the second acoustic energy resulting from the second acoustic energy being redirected by the target of interest; and a processor for determining a range associated with the target of interest dependently upon the delay.

### FIELD OF THE INVENTION

The present invention relates to sound navigation and ranging (SONAR) systems.

### BACKGROUND OF THE INVENTION

In order to determine the range and bearing of an underwater target, active SONAR transmissions may be conventionally employed. In active SONAR systems, acoustic energy signals are emitted from a platform towards the target followed by a reception of the echo; the elapsed time and any modulation of the transmitted signal providing target data. A drawback of the active echo ranging approach, is that upon transmission, the transmitting SONAR platform tends to reveal its presence and location. In fact, it is believed that active echo ranging is indeed quite revealing of the transmitting platform. It is often desirable not to reveal such information.

In contrast, there is no active transmission of acoustic energy towards the target in a passive mode SONAR system. In a passive mode SONAR system, the receivers are tuned to receive signals that may emanate from the target, with target data being based on the measurement of bearing of the target relative to the moving vehicle. Although in general, no range information is obtained, a passive mode of operation is advantageous for, and often used in, situations wherein it is desirable that the measurement operation should go unnoticed by third parties and by personnel associated with the target of interest. However, in ocean environments, particularly in littoral waters, there is usually an abundance of SONAR-interfering noise, such as that conventionally emanating from surface vessels. Such interfering noise is often a hindrance to target detection. Historically, considerable efforts have been made to reduce or eliminate such interfering or ambient noise in the process of attempting to detect and range underwater targets of interest.

### SUMMARY OF THE INVENTION

A system and associated method for ranging an underwater target of interest using ambient acoustic energy, the system including: a hydrophone; a correlator for correlating first and second acoustic energy to determine a delay associated with the second acoustic energy resulting from the second acoustic energy being redirected by the target of interest; and, a processor for determining a range associated with the target of interest dependently upon the delay.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts, and:

FIG. 1 illustrates an ocean environment including a system according to an aspect of the present invention;

FIG. 2 illustrates an ocean environment including a system according to an aspect of the present invention;

FIG. 3 illustrates a block diagram representation of a system according to an aspect of the present invention; and,

FIG. 4 illustrates data that may be used according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding, while eliminating, for the purpose of clarity, many other elements found in typical sound navigation and ranging (SONAR) systems and methods of making and using the same. Those of ordinary skill in the art may recognize that other elements and/or steps may be desirable in implementing the present invention. However, because such elements and steps are well known in the art, and because they do not facilitate a better understanding of the present invention, a discussion of such elements and steps is not provided herein.

According to an aspect of the present invention, sound ranging of a target of interest may be accomplished notwithstanding the presence of ambient noise, and without the use of revealing active echo ranging. According to an aspect of the present invention, ambient acoustic energy may be used to detect and range underwater targets of interest.

According to an aspect of the present invention, a method and system embodying the present invention enables clandestine active echo ranging by exploiting the normally present ambient noise, such as that which emanates from surface vessel traffic, as an active, and generally broadband and time-continuous, acoustic transmission source. The method and system of the present invention utilize the normally interfering “noise” as an asset instead of considering the noise as interference, which must be eliminated. The acoustic noise or interfering signals may be used as an off-platform acoustic transmission source to which bistatic sonar processing can be applied. Target bearing and ranging can thus be achieved without requiring active transmission by the sonar platform.

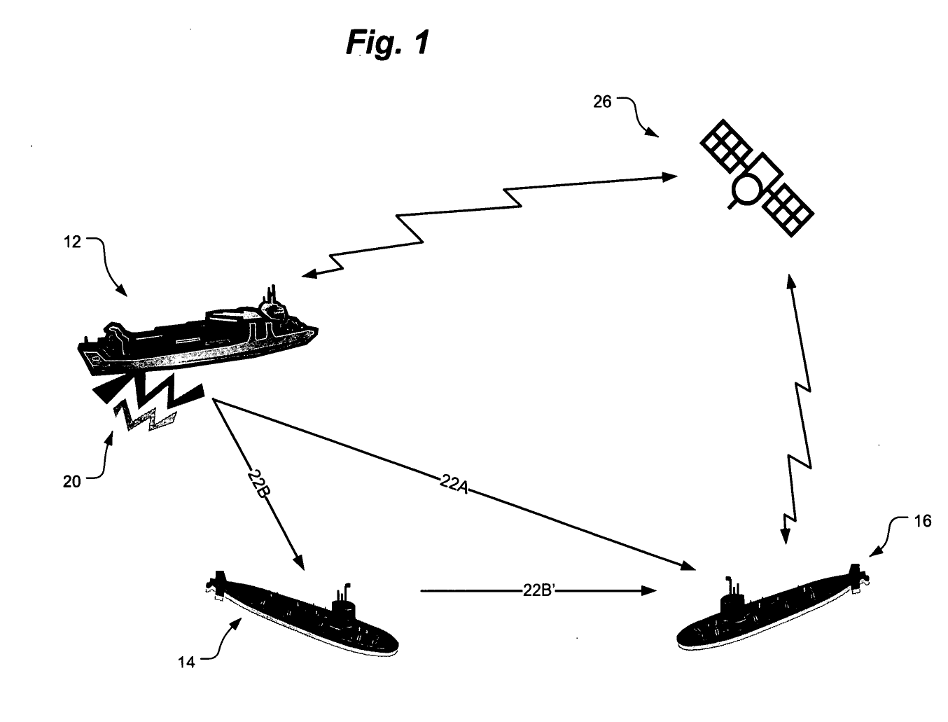

Referring now to the figures, wherein like references identify like elements of the invention, FIG. 1 schematically depicts an exemplary configuration of a passive detection system according to an aspect of the present invention. The system generally uses one or more acoustic energy sources 12 to detect and range one or more targets of interest 14, and includes a receiving platform 16 in accordance with an embodiment of the invention.

Acoustic energy source 12 may take the form of any source of ambient noise suitable for being directly detected by platform 16, and for reflecting from a target of interest 14 and subsequently being detected by platform 16. Acoustic energy source 12 may take the form of one or more conventional surface vessels, for example. Source 12 may take the form of military, commercial or private surface vessels, for example. While one source 12 is shown in FIG. 1 for explanatory purposes, it is understood that a passive detection system in accordance with the present invention may operate using other numbers of sources 12 positioned at various locations. Optionally, more sources may be used to increase the certainty of measurements, for example.

Referring still to FIG. 1, each source 12 causes acoustic energy signals, e.g., noise, to propagate from it during the ordinary course of operation. Such energy signals have conventionally been considered ambient noise that tends to mask the target of interest the receiving platform 16 is attempting to detect. Accordingly, conventional detection and ranging techniques filter out or otherwise compensate for such undesirable noise signals received at platform 16.

In general, each source 12 may include broadband and narrow-band acoustic energy sources. As will be understood by those possessing an ordinary skill in the pertinent arts, broadband sources tend to emanate acoustic energy over a wide range of frequencies. Typical noise components of broadband acoustic energy include noise from propellers and shafts, and flow noise (such as steam). Noise from a propeller and shaft is generally at low frequency, meaning less than about 1000 Hertz (Hz). Of course, energy at other frequencies may be used, so long as it propagates through sea water at a suitable efficiency to reach receiving platform 16 in a measurable manner. Broadband acoustic energy may range from several hundred Hz to a several KHz, such as about 200 Hz to about 4000 Hz, by way of non-limiting example only. It should be understood however that bandwidth limits may be based on the source bandwidth and the receiver bandwidth. The narrower of these two setting the limit.

On the other hand, narrowband sources are centered about particular frequencies. Typical noise components of narrowband acoustic energy include noise from pumps, motors and electrical generation equipment.

According to an aspect of the present invention, the use of ambient broadband acoustic energy may be preferred to the use of pure narrowband acoustic energy. Pure narrowband acoustic energy may tend to produce a sinusoidal correlation output with many peaks. This may result in ambiguities. Broadband energy on the other hand tends to provide a single, distinct peak, whose magnitude (gain) is proportional to the bandwidth of the broadband energy in a correlation process, as the gain is proportional to the bandwidth. Thus, as narrowband signals tend to degrade the correlation because of the periodic nature of narrowband correlation, these narrowband signals may optionally be removed prior to correlation. This may be done by performing spectral analysis (via FFTs, for example), picking out the narrowband components, and removing them from the spectral data. This data may then either be converted back to the time domain for time-domain correlation, or else the correlation performed in the frequency domain. In either case, the narrowband energy may be removed. That being said however, narrowband acoustic energy may be considered when correlating received acoustic energy as is described herein throughout.

The position of source 12 may be determined using any conventional methodology, such as the Global Positioning System (GPS) 26 or radio frequency (RF) triangulation, for example. The position of source 12 may be provided to receiving platform 16 in a conventional manner, such as by using conventional communications channels.

Target 14 may include one or more potential targets of interest, such as a submarine or underwater mine, for example. Receiving platform 16 may take the form of any platform including a receiver having the ability to receive the acoustic energy to be processed. Platform 16 may include a processor for processing received acoustic energy. In an exemplary embodiment of the invention, receiving platform 16 may be integrated into a SONAR system of a submarine or included as a set of acoustic hydrophones part of a fixed underwater passive SONAR array.

Referring still to FIG. 1, acoustic energy 20 propagates according to well understood laws of physics. A portion of acoustic energy 20 is received by the receiving platform 16 directly. This is illustrated in FIG. 1 by signal 22A. The distance between emanating source 12 to receiving platform 16 is designated D_{A} (not shown). A portion of acoustic energy 20 propagates toward target 14 (shown as signal 22B) and is then reflected toward the receiving platform 16 (shown as signal 22B′). The distance between target 14 and source 12 is designated D_{B} (not shown). The distance between target 14 and receiving platform 16 is designated D_{B′} (not shown). Thus, receiving platform 16 receives interfering energy propagating directly from source 12 and indirectly in the form of energy signals reflected off of target of interest 14.

From the perspective of receiving platform 16, corresponding portions of the reflected signal 22B′ and signal 22A will arrive at different times. That is, a same portion of the acoustic energy 20 will arrive at receiver 16 at different times as parts of signals 22A and 22B′. The reflected energy 22B′ are delayed in time with respect to the direct energy 22A due to the realization that D_{A}≠D_{B}+D_{B′}. Thus, performing a cross-correlation function, with respect to time, on the reflected energy and direct energy will result in a maximum value corresponding to the time difference on arrival (TDOA) to the receiving platform 16. The results of this cross-correlation function can be used to obtain kinematic information (e.g., bearing, range) pertaining to the target of interest 14 reflecting signal 22B′.

According to an aspect of the present invention, and distinct from conventional passive SONAR applications, the source of received acoustic energy is not the target itself. Rather there are separate sources and targets. That being said, a system according to the principles hereof may be used in addition to or in lieu of a conventional active and/or passive SONAR system.

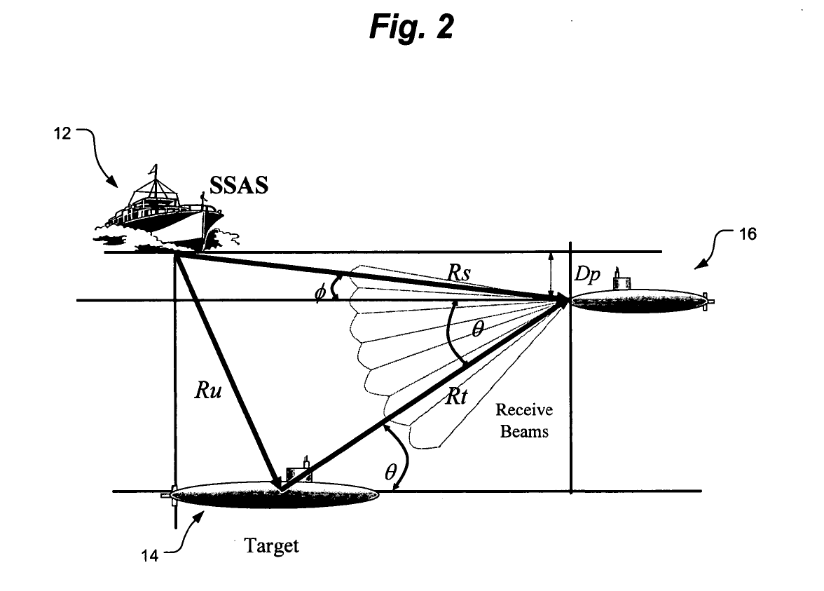

Referring now also to FIG. 2, it is shown that to a first order effect, the noise signal from a surface ship 12 propagates directly to platform 16, e.g., a ship sonar sensor, and is also reflected off target of interest 14. The reflected energy is also detected by platform 16, e.g., ship sonar. Since the reflected path will be longer than the direct path, the reflected path acoustic energy will arrive some time after that of the direct path. This time delay can be measured by correlating the direct path return in one receive beam with other receiver beams to obtain an angle and a time delay estimate in accordance with the known location of the source 12, e.g., surface ship. This information, coupled with the geometry illustrated in FIG. 2, can be used via a passive detection system according to an aspect of the present invention to determine the range and bearing to target 14.

The illustrated schematic diagram of FIG. 2 uses a simplified geometrical approach useful for demonstrating the processing, measurement determinations and calculations for obtaining range and bearing of the target of interest according to an aspect of the present invention. While the simplified schematic diagram of FIG. 2 illustrates a straight-line analysis useful for demonstrating the principles of the present invention, it is understood that the sound propagation paths may be more complex, and can be accounted for to a degree through use of sound velocity profiles and knowledge of the general area, for example. For purposes of explanation only, it is also assumed for this analysis that surface ship 12, target 14 and receiving platform 16 lie in the same vertical plane.

Under these simplifying assumptions, the geometry shown in FIG. 2 can be used to derive the target range, where: Rs is the slant range to acoustic source 12; Rt is the slant range to target 14; Ru is the slant range from acoustic source 12 to target 14; Dp is the depth of the receiving platform 16; θ is the depression angle of target 14; φ is the elevation angle of acoustic source 12; and c is the speed of sound in the environment.

Upon receiving platform 14 determining the location of acoustic source 12, the angle θ can be determined from correlation and beam forming methods. For example, once the correlation process identifies the beam location of a correlated target, beam interpolation can be used to determine the corresponding depression angle. The range from the platform to the acoustic source can be determined by information obtained from a global positioning system, or other intelligence source, which can be telemetered to the receiving platform in the form of a radio link, for example. Alternatively, a range to a surface ship acting as a source may be acquired in a conventional way, such as by using a periscope, for example. Therefore, known quantities are Rs, Dp, φ, and θ.

By correlating the direct path beam with the indirect path beam, the relative time delay between the two paths, Δt, can be determined. Once this measurement is made, it can be used to determine range as follows:
cΔt=Rᵤ+Rₜ−Rₛ Eq. (1)
Solving for Rᵢ,
Rₜ=cΔt+Rₛ−Rᵤ Eq. (2)
where Rᵤ can be written as
Rᵤ=\sqrt{(Dₚ+Rₜ sin θ)²+(Rₛ cos θ)²} Eq. (3)
which yields:
Rₜ=cΔt+Rₛ−\sqrt{(Dₚ+Rₜ sin θ)²+(Rₛ cos φ−Rₜ cos θ)²} Eq. (4)
Solving for Δt results in,

$$Δ t = \frac{{R}_{t} - {R}_{s} + \sqrt{{( {D}_{p} + {R}_{t} sin θ )}^{2} + {( {R}_{s} cos ϕ - {R}_{t} cos θ )}^{2}}}{c} \qquad Eq . ( 5 )$$

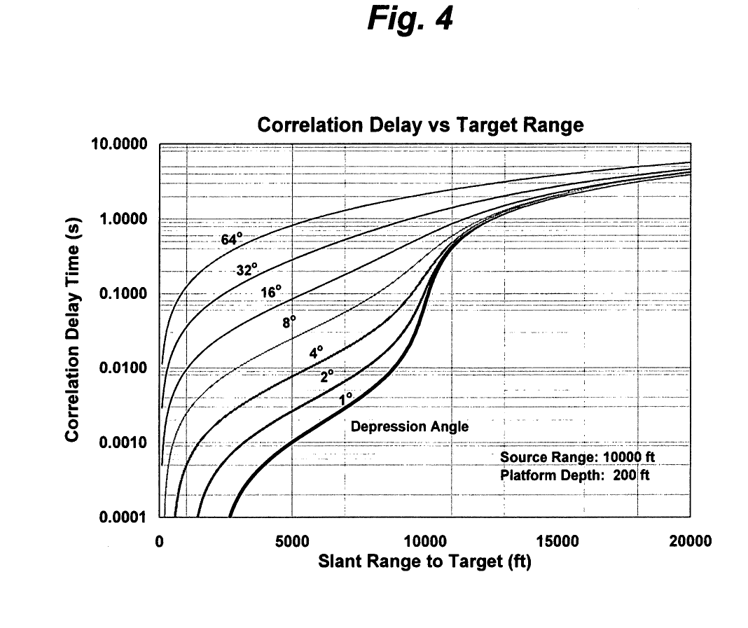

Referring now also to FIG. 4, there is shown a graphical representation corresponding to Eq. 5 for a receiving platform depth of 200 feet, and a source range of 10,000 feet for various depression angles.

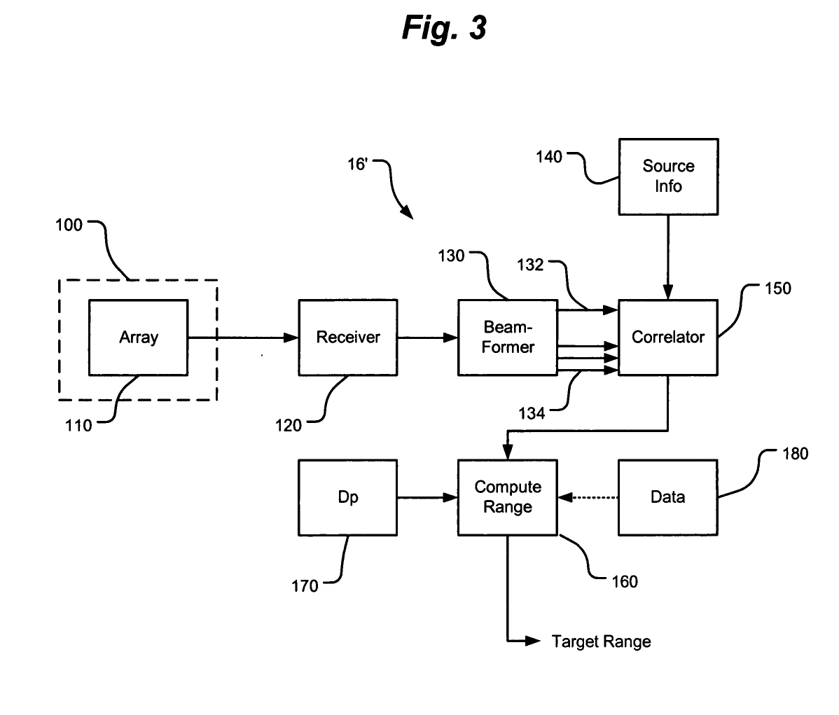

Referring now also to FIG. 3, by way of further non-limiting example only, there is shown a system 16′, suitable for use as a receiving platform 16, according to an aspect of the present invention. System 16′ may include one or more hydrophones 100, a receiver 120, a beam-forming processor 130, a correlator 150 and a range computer 160. Basically, hydrophone 100 may include an array 110 of acoustic energy sensitive elements. Suitable arrays may include spherical arrays, cylindrical arrays and towed arrays, all by way of non-limiting example only. Some arrays may provide inherent advantages over other arrays, as for example a spherical array may provide a wider elevational field of view than a cylindrical array. Receiver 120 may take the form of a conventional receiver for operating array 110.

Beam-forming processor 130 shifts inputs from receiver 120, such as by time delaying or phase shifting, to acquire each of a plurality of beams 132, 134. One or more of the acquired beams may correspond to a source beam 132 received directly from source 12 (FIG. 1). One or more of the acquired beams may correspond other receive beams 134, such as those from source 12 (FIG. 1) reflected off of target 14 (FIG. 1), (i.e. reflected beams). Regardless, beams 132, 134 may be monitored nearly simultaneously through repetition with varying delays/shifts, for example. Correlator 150 may use positioning information 140 about source 12 (FIG. 1) (such as range and bearing) and the output of beam-former 130 to correlate the directly received beam(s) 132 with the other received beam(s) 134. Correlator 150 may provide a correlation delay between the received signals. The computation of bearing, depression, θ, Δt, and potential target directions are performed in correlator 150 and may be determined in conventional manners. Delay times determined by correlation, target depression and target bearing output from correlator 150 may be used as input to range computer 160 along with acoustic source information (i.e., range) 140, platform depth data Dp 170, and correlation/target range parameter data 180 to compute the range to the reflecting target, for example. Temporal averaging of the correlated data may increase the signal to noise ratio (SNR) and provide an enhanced output signal for determining target range.

Referring again to FIG. 4, there is shown a graphical representation of correlation delay versus target range for a source range of 10000 feet and a platform depth of 200 feet for various depression angles. Data 180, such as data analogous to that shown in FIG. 4, may be used by range computer 160, such as in the form of a look-up table, to determine a range from the determined signal delay found via correlator 150. Of course, computer 160 may operate in other manners as well—such as by direct computation. Such computation may be consistent with Eq. 5, in the case of a 2-dimensional analysis for example. Such a computation, or the use of sophisticated look-up table(s), may take factors, such as a three-dimensional consideration, and/or the temperature and salinity of the medium sea water, into account.

Finally, conventional post-processing, analysis and display may be effected.

Those of ordinary skill in the art may recognize that many modifications and variations of the present invention may be implemented without departing from the spirit or scope of the invention. For example, use of multiple sources of ambient noise may mitigate multipath effects as different acoustic paths can exist for each acoustic source. The multipath returns may generally be different for each source while the main similarity in the paths would be the target itself, thereby enabling some distinction of the signal from multipath returns. Use of dedicated reference beams for each of the acoustic sources for maximizing receiver responses, receive beam null placement for correlation are also contemplated. Thus, it is intended that the present invention covers the modifications and variations of this invention provided they come within the scope of the appended claims and their equivalents.

1. A method for ranging an underwater target of interest comprising:
receiving first acoustic energy directly from a source;
assigning a dedicated reference beam to said source:
receiving second acoustic energy from said source that has been redirected by the underwater target of interest;
correlating said dedicated reference beam and second acoustic energy to determine a delay associated with said second acoustic energy; and,
determining a range associated with the target of interest dependently upon said delay.

2. The method of claim 1, wherein said source is distinct from the target of interest.

3. The method of claim 1, wherein the source comprises at least one surface vessel.

4. The method of claim 1, wherein the source comprises a broadband source.

5. The method of claim 4, further comprising filtering out narrowband acoustic energy.

6. The method of claim 1, wherein said first and second acoustic energy includes acoustic energy having a frequency below about 4000 Hz.

7. The method of claim 1, further comprising determining a location of the source, wherein said determining the range associated with the target of interest dependently upon said delay is dependent upon said location of the source.

8. A system for ranging an underwater target of interest using ambient acoustic energy from an acoustic source of known position, the system comprising:
a hydrophone;
a correlator for correlating first and second acoustic energy originating from said acoustic source to determine a delay associated with said second acoustic energy resulting from said second acoustic energy being redirected by the target of interest; and
a processor for determining a range associated with the target of interest dependently upon said delay and said position of said acoustic source.

9. The system of claim 8, further comprising a memory storing data indicative of rangers and associated delays.

10. The system of claim 8, wherein said source is distinct from the target of interest.

11. The system of claim 8, wherein the source comprises at least one surface vessel.

12. The system of claim 8, wherein the source comprises a broadband source.

13. The system of claim 12, further comprising a filter for filtering out narrowband acoustic energy.

14. The system of claim 12, wherein said first and second acoustic energy includes acoustic energy having a frequency below about 4000 Hz.

15. A computer program product being embodied on a computer readable medium and for ranging an underwater target of interest using information indicative of received ambient acoustic energy from an acoustic source of known position, the computer program product comprising code for:
correlating first and second portions of the received ambient acoustic energy to determine a delay associated with said second portion of the received ambient acoustic energy; and
determining a range associated with the target of interest dependently upon said delay and said position of said acoustic source.

16. The computer program product of claim 16, further comprising data indicative of ranges and associated delays.

17. The computer program product of claim 16, wherein said source is distinct from the target of interest.

18. The computer program product of claim 15, wherein the source comprises a broadband source.

19. The computer program product of claim 18, further comprising code for filtering out narrowband acoustic energy.

20. The computer program product of claim 15, wherein the delay
$$Δ t = \frac{{R}_{t} - {R}_{s} + \sqrt{{( {D}_{p} + {R}_{t} sin θ )}^{2} + {( {R}_{s} cos ϕ - {R}_{t} cos θ )}^{2}}}{c} ,$$
where Rs is the slant range to the source of the ambient acoustic energy; Rt is the slant range to the target; Ru is the slant range from the source of the ambient acoustic energy to the target; Dp is the depth of a receiving platform; θ is the depression angle of the target; φ is the elevation angle of the source of the ambient acoustic energy; and c is the speed of sound in the environment.
